(19) United States
(12) Patent Application Publication
(10) Pub. No.: US 2026/0209041 A1
(43) Pub. Date: Jul. 23, 2026

(54) PROCESS FOR PURIFYING BIS(FLUORO SULFONYL)IMIDE SALTS

(71) Applicant: SPECIALTY OPERATIONS FRANCE, Lyon (FR)

(72) Inventors: Richard Smith, Sainte-Foy-lès-Lyon (FR); Salvador Asensio Delgado, Lyon (FR); Arnaud Colin, Solaize (FR); Etienne Schmitt, Soucieu-en-Jarrest (FR)

(73) Assignee: SPECIALTY OPERATIONS FRANCE, Lyon (FR)

(21) Appl. No.: 19/139,841

(22) PCT Filed: Nov. 21, 2023
(86) PCT No.: PCT/EP2023/082566

§ 371 Date: Jun. 16, 2025

(30) Foreign Application Priority Data
Dec. 15, 2022 (EP) 22306894.1

(51) Int. Cl. C01B 21/093

(52) U.S. Cl. CPC C01B 21/0935; C01P 2006/82

(57) ABSTRACT

A method for purifying a composition comprising a salt of bis(fluoro sulfonyl)imide in the form of a solution, wherein the method comprises the steps of: (I) providing a composition comprising at least one solvent, water in an amount of at least 100 ppm, and at least one salt of bis(fluoro sulfonyl)imide in a first concentration (salt-FSI 1); (II) charging the composition (COMP) into a vessel; (III) subjecting the composition (COMP) to distillation; and (IV) recovering a composition comprising at least one organic solvent, water in an amount lower than 100 ppm, and the at least one salt-FSI in a second concentration (salt-FSI 2), wherein the second concentration (salt-FSI 2) is higher than the first concentration (salt-FSI 1) in the composition (COMP).

### CROSS-REFERENCE TO RELATED PATENT APPLICATIONS

This application claims priority filed on 15 Dec. 2022 in Europe with Nr. 22306894.1, the whole content of this application being incorporated herein by reference for all purposes.

### Technical field

The present invention relates to a process for the purification of a solution of bis(fluoro sulfonyl)imide salt.

### BACKGROUND

Bis(fluoro sulfonyl)imide (FSI) and salts thereof, in particular the lithium salt of bis(fluoro sulfonyl)imide (LiFSI), are useful compounds in a variety of technical fields, including for the manufacture of battery electrolytes.

Several methods for the manufacture of FSI and its salts have been described in the art. Among the various technologies described, most of the manufacturing methods comprise a fluorination reaction, wherein a fluorinating agent is reacted with a suitable compound, in a solvent.

Many efforts have been taken in the art to improve the manufacturing methods of FSI salts and of the intermediate compounds thereof, in particular with regard to purity and yield of the intermediate and final compounds and cost reduction of the overall manufacturing method.

Also, salts of FSI are known to be sensitive to water and can react to form unwanted species, which severely degrade the quality and the electrochemical properties of the FSI salt.

EP 3494085 (in the name of Arkema) discloses a method for drying and purifying LiFSI salt in an organic solvent (S1) and a composition containing LiFSI and water in an amount between 5 and 45 ppm by mass. The method in particular comprises the following steps: a) adding deionized water to extract LiFSI, forming an aqueous solution of the salt, a') optionally concentrating such aqueous solution, b) extracting LiFSI from the aqueous solution with an organic solvent (S2) forming an azeotropic mixture with water, c) concentrating LiFSI by evaporating the organic solvent, d) optionally crystallizating LiFSI.

### SUMMARY OF THE INVENTION

The Applicant is aware that despite all the attempts in the art, there is still the need for a process for the purification of salts of bis(fluoro sulfonyl)imide (salt-FSI), in particular for the removal of water, which is efficient and can be easily scaled up from lab to pilot and industrial scale.

More in particular, the Applicant faced the problem of providing a process, which allows purifying the salt-FSI, with no degradation of the same and with a high recovery yield, even when applied at industrial scale.

Surprisingly, the Applicant developed a new process for the purification of salts of FSI, which meets the above mentioned criteria and needs, and that can be easily scaled up from the laboratory scale to pilot and industrial plant.

An advantage of the process of the present invention is that the overall purification time is very short. For example, the overall process may last even less than one hour, while no degradation of the starting salt-FSI occurs even if the process lasts for 5 or 10 hours, or even longer.

Another advantage of the process of the present invention is that the solvent and water obtained as waste products can be further recycled.

### DRAWINGS

FIG. 1 represents a scheme of the laboratory setup used in Example 1.

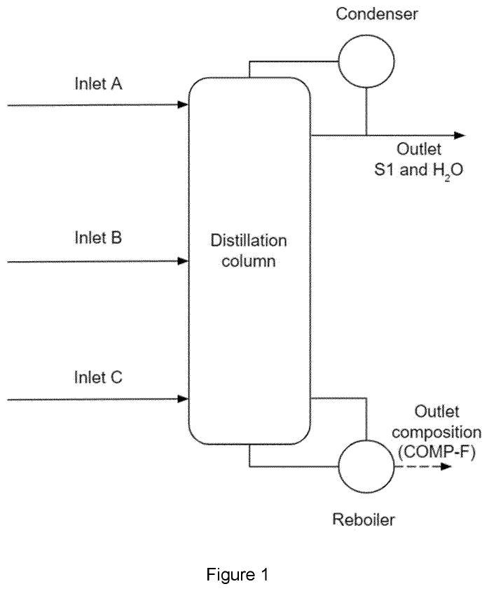

### DISCLOSURE OF THE INVENTION

In the present application:
the numerical ranges includes the limits, unless otherwise specified;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list;
the term “ppm” (or “part per million”) refers to a weight fraction over the total weight of the composition, unless specified otherwise.

The present invention relates to a method for purifying a composition comprising a salt of bis(fluoro sulfonyl)imide [salt-FSI], said composition being in the form of a solution, said method comprising the steps of:
(I) providing a composition [composition (COMP)] comprising:
   at least one solvent [solvent (S1)],
   water in an amount of at least 100 ppm, and
   at least one salt of bis(fluoro sulfonyl)imide [salt-FSI] in a first concentration (salt-FSI 1);
(II) charging said composition (COMP) into a vessel;
(III) subjecting said composition (COMP) to distillation;
(IV) recovering a composition [composition (COMP-F)] comprising:
   at least one organic solvent [solvent (S1)],
   water in an amount lower than 100 ppm, and
   the at least one salt-FSI in a second concentration (salt-FSI 2), said second concentration (salt-FSI 2) being higher than said first concentration (salt-FSI 1) in composition (COMP).

Preferably, said at least one salt-FSI is a salt of bis(fluoro sulfonyl)imide with one of: lithium, sodium, potassium, zinc, or magnesium. Lithium, sodium and potassium are more preferred.

The term “charging” or “charge” hereby means that the composition described herein is placed into a vessel (also called recipient or device) suitable for performing the subsequent step of distillation. Within the context of the present invention, “charging the composition in the vessel” is equivalent to “adding” or “feeding” or “injecting” the composition to the vessel.

The term “recovering” hereby means that the composition (COMP-F) is removed or withdrawn from the vessel wherein the previous steps take place.

The term “vessel” hereby means a container which is well-suited for the method of the present invention, that-is-to-say which is adapted to withstand the pressures and temperatures used in the method of the present invention, as well as to the possible corrosive character of the reactants and products involved in this method.

According to a preferred embodiment, steps (II) and (III) are performed simultaneously.

More preferably, steps (II), (III) and (IV) are performed simultaneously.

Even more preferably, steps (I) to (IV) are performed simultaneously.

The configuration of the equipment for performing the method of the present invention is not limited. The equipment can be advantageously configured in a batch, semi-batch or continuous distillation system.

Preferably, for performing the method of the present invention, such a vessel is preferably a distillation column, or a container, such as a boiler, equipped with a distillation column.

Preferably, said composition (COMP) comprises the salt-FSI in a concentration from about 0.1 to about 35 wt. %, more preferably from about 0.5 to 30 wt. % and even more preferably from 1 to 20 wt. % based on the total weight of the composition (COMP).

Preferably, said composition (COMP) comprises water in an amount of at least 120 ppm, more preferably of at least 150 ppm, even more preferably of at least 500 ppm based on the total weight of composition (COMP).

The maximum amount of water in composition (COMP) is not limited as any water content of composition (COMP) is compatible with the method according to the present invention. However, composition (COMP) preferably comprises water in an amount up to 5,000 ppm, more preferably up to 30,000 ppm based on the total weight of composition (COMP).

Preferably, said at least one solvent (S1) is selected in the group comprising optionally fluorinated carbonate solvents, such as: ethylene carbonate, fluoroethylene carbonate, vinylene carbonate, propylene carbonate, butylene carbonate, dimethyl carbonate, ethyl methyl carbonate (EMC), diethyl carbonate; lactones, such as: y-butyrolactone, y-valerolactone; ethers, such as: dimethoxymethane, 1,2-dimethoxyethane, tetrahydrofuran, 2-methyl tetra hydrofuran, 1,3-dioxane, 4-methyl-1,3-dioxolane; optionally fluorinated esters, such as: methyl formate, methyl acetate, ethyl acetate, methyl propionate, isopropyl acetate, n-butyl acetate, n-propyl propionate, 2,2-difluoroethyl acetate; and polar aprotic solvents, such as: sulfolane, 3-methyl sulfolane, dimethylsulfoxide, N, N-dimethylformamide, N-methyl oxazolidinone, acetonitrile, valeronitrile, benzonitrile, nitromethane and nitrobenzene.

More preferably, said solvent (S1) is selected from optionally fluorinated carbonate solvents and esters.

Even more preferred solvent (S1) is selected from dimethyl carbonate, ethyl methyl carbonate (EMC), diethyl carbonate, ethyl acetate, isopropyl acetate and n-butyl acetate.

According to a more preferred embodiment, said solvent (S1) is selected from ethyl methyl carbonate (EMC), dimethyl carbonate and n-butyl acetate.

The amount of said at least one solvent (S1) in composition (COMP) is such to arrive at 100 wt. % of the composition (COMP).

According to a preferred embodiment, solvent (S1) is an electronic grade solvent.

Composition (COMP) can be prepared according to any method known in the art.

Preferably, composition (COMP) is obtained in the form of a solution from a manufacturing method and used in step (I) of the process of the invention as such.

Alternatively, a predetermined amount of salt-FSI in the solid form is dissolved into a suitable organic solvent. Said organic solvent is preferably solvent (S1) as defined above.

Preferably, step (II) is performed via a pump or by gravity.

In step (II), composition (COMP) is charged into the vessel via proper means. Preferably, such a means is a nozzle or an injector.

In step (II), composition (COMP) can be charged sequentially, either semi-continuously or continuously.

Preferably, composition (COMP) is continuously charged into the vessel.

Alternatively, composition (COMP) is semi-continuously charged into the vessel. For example, composition (COMP) is charged into the vessel for a certain time, such as for example between 30 and 120 seconds, preferably for about 60 seconds, and then the charging is stopped for another period of time, which can be equal to, shorter or longer than the charging time.

Preferably, step (III) is performed via a distillation column.

Preferably, at the top of said distillation column, a reflux ratio of water and solvent (S1) of from about 0.1 to about 100, or even higher, is maintained.

Preferably, step (III) is performed at a pressure below 500 mbar abs (0.05 MPa), more preferably below 300 mbar abs (0.03 MPa), even more preferably below 150 mbar abs (0.015 MPa) or below 50 mbar abs (0.005 MPa).

Under step (IV), composition (COMP-F) is continuously recovered.

Preferably, step (IV) is performed via a pump or gravity.

Preferably, said composition (COMP-F) comprises the salt-FSI in a concentration from about 0.2 to about 70 wt. %, more preferably from about 1.0 to 60 wt. % and even more preferably from 2 to 40 wt. % based on the total weight of the composition (COMP-F).

Preferably, said composition (COMP-F) comprises water in a concentration below 150 ppm, more preferably below 100 ppm, more preferably below 50 ppm based on the total weight of the composition (COMP-F).

Preferably, steps (II) and (III) are performed simultaneously and step (IV) is started after said steps (II) and (III).

At the end of step (IV) or while step (IV) proceeds, water optionally in admixture with solvent (S1) is obtained as distillate product(s). Said distillate product(s) can be advantageously recycled in a separate method or process.

Preferably, composition (COMP-F) contains at least one other substance. Said at least one other substance is preferably selected from:
fluoride (F—) preferably in an amount less than 100 ppm, as measured by Ionic Chromatography (IC); and/or
chloride (CI—) preferably in an amount less than 100 ppm, as measured by IC; and/or
sulfate (SO₄²—) preferably in an amount less than 1,000 ppm, as measured by IC; and/or
sulfamate (NH₂SO₃—) preferably in an amount less than 1,000 ppm, as measured by IC; and/or
fluorosulfonate (FSO₃) preferably in an amount less than 1,000 ppm, as measured by IC.

Preferably, the amounts of said at least one other substance in composition (COMP-F) are preferably as follows:
fluoride (F—) in an amount up to 50 ppm, for example less than 40 ppm, less than 30 ppm, less than 25 ppm;
chloride (Cl—) in an amount up to 50 ppm, for example less than 40 ppm, less than 30 ppm, less than 20 ppm, less than 10 ppm or even less than 8 ppm;
acid substances different from sulfate (SO₄²—) in an amount up to 100 ppm, for example less than 50 ppm, less than 30 ppm, less than 25 ppm; the amounts being measured by lonic Chromatography (IC).

Preferably, said acid substances different from sulfate (SO₄²—) are selected from NH₂SO³— and/or FSO₃—.

Preferably, said acid substances different from sulfate (SO₄²—) are in the following amounts:
less than 50 ppm of sulfamate (NH₂SO₃—), for example less than 40 ppm, less than 30 ppm, less than 20 ppm, less than 10 ppm or even less than 5 ppm as measured by IC; and/or
less than 50 ppm of fluorosulfonate (FSO₃—), for example less than 40 ppm, less than 30 ppm, less than 20 ppm, less than 10 ppm or even less than 5 ppm as measured by IC.

Should the disclosure of any patents, patent applications, and publications which are incorporated herein by reference conflict with the description of the present application to the extent that it may render a term unclear, the present description shall take precedence.

The present invention will be now described in more detail with reference to the following examples, whose purpose is merely illustrative and not intended to limit the scope of the disclosure.

### EXAMPLES

### Example 1—Continuous Process

A composition in the form of solution containing LiFSI (10 wt. %) in EMC, and water in an amount of 2500 ppm to the overall weight of the composition, was continuously fed for 6 hours to a distillation column (1.8 m high and diameter equal to 5 cm, with structured packing and comprising approximately 20 theoretical stages) previously set at 20 mbar abs (0.002 MPa) and 20° C. in column head, via an inlet from a storage vessel. The feeding was performed operating continuously under vacuum at 20 mbar abs (0.002 MPa). At the top of the column, a reflux ratio between water and EMC of about 1 to 2 was used.

As the distillation proceeded, a solution of LiFSI in EMC was continuously removed from the bottom of the column and EMC/H₂O was continuously removed from the top of the column.

The process was continued for 6 hours, when steady-state operation was reached and a composition in the form of a solution of LiFSI (26.3 wt. %) in EMC and containing water in an amount lower than 20 ppm to the overall weight of the mixture, as determined by Karl-Fischer titration in EMC, was obtained.

### Example 2—Batch Process

623 g of a composition in the form of a solution comprising LiFSI (30 wt. %) in EMC and 1372 g of EMC/H₂O (3381 ppm of water) were fed to a distillation column as described in Example 1 above. A total of 1995 g of LiFSI (9.4 wt. %) comprising water in an amount of 2300 ppm to the overall weight of the composition were fed to the same column.

Distillation started by applying 20 mbar abs (0.002 MPa), 20° C., steadily increasing to 27° C. as the process proceeded. Around 900 g of a mixture of EMC/H₂O were distilled with time-decreasing water concentration as measured by Karl-Fisher titration until a range from 1100 to 600 ppm was obtained.

432 g of EMC containing 25 ppm of water were then added. Distillation was continued at 20 mbar abs (0.002 MPa) and temperature rising from 20 to 27° C., and about 600 g of a mixture of EMC/H₂O were distilled, having a water content from 600 to 300 ppm as measured by Karl-Fisher titration in EMC.

The LiFSI solution obtained at the bottom of the column contained 52 ppm of water according to KF titration, and an amount of LiFSI of about 28 wt. %, as determined by NMR.

1. A method for purifying a composition comprising a salt of bis(fluoro sulfonyl)imide [salt-FSI] said composition being in the form of a solution, said method comprising the steps of:
(I) providing a composition [composition (COMP)] comprising:
at least one solvent [solvent (S1)],
water in an amount of at least 100 ppm, and
at least one salt of bis(fluoro sulfonyl)imide in a first concentration (salt-FSI 1);
(II) charging said composition (COMP) into a vessel;
(III) subjecting said composition (COMP) to distillation;
(IV) recovering a composition comprising:
at least one organic solvent,
water in an amount lower than 100 ppm, and
the at least one salt-FSI in a second concentration (salt-FSI 2), said second concentration (salt-FSI 2) being higher than said first concentration (salt-FSI 1) in composition (COMP).

2. The method according to claim 1, wherein said salt-FSI is a salt of bis(fluoro sulfonyl)imide with one of: lithium, sodium, potassium, zinc, or magnesium.

3. The method according to claim 1, wherein:
at least steps (II) and (III) are performed simultaneously; and/or
at least steps (II), (III) and (IV) are performed simultaneously.

4. The method according to Claim 1, wherein said composition (COMP) comprises the salt-FSI in a concentration from 0.1 to 35 wt. % based on the total weight of the composition (COMP).

5. The method according to Claim 1, wherein said composition (COMP) comprises water in an amount of at least 120 ppm based on the total weight of the composition (COMP).

6. The method according to Claim 1, wherein said composition (COMP) comprises water in an amount up to 30,000 ppm based on the total weight of the composition (COMP).

7. The method according to Claim 1, wherein said solvent (S1) is selected in the group comprising optionally fluorinated carbonate solvents optionally flouorinated esters, and polar aprotic solvents,

8. The method according to claim 1, wherein step (III) is performed:
via a distillation column maintaining a reflux ratio at the top of said distillation column of from 0.1 to 100; and/or
at a pressure below 500 mbar abs (0.05 MPa).

9. The method according to Claim 1, wherein said composition (COMP-F) comprises the salt-FSI in a concentration from about 0.2 to about 70 wt. % based on the total weight of the composition (COMP-F).

10. The method according to Claim 1, wherein said (COMP-F) comprises water in an amount below 150 ppm based on the total weight of the composition (COMP-F).

11. The method according to claim 1, wherein said composition (COMP) comprises the salt-FSI in a concentration from 0.5 to 30 wt. % based on the total weight of the composition (COMP).

12. The method according to claim 1, wherein said composition (COMP) comprises the salt-FSI in a concentration from 1 to 20 wt. % based on the total weight of the composition (COMP).

13. The method according to claim 1, wherein said composition (COMP) comprises water in an amount of at least 150 ppm based on the total weight of the composition (COMP).

14. The method according to claim 1, wherein said composition (COMP) comprises water in an amount of at least 500 ppm based on the total weight of the composition (COMP).

15. The method according to claim 7, wherein the fluorinated carbonate solvents are selected from the group of ethylene carbonate, fluoroethylene carbonate, vinylene carbonate, propylene carbonate, butylene carbonate, dimethyl carbonate, ethyl methyl carbonate (EMC), and diethyl carbonate.

16. The method according to claim 7, wherein the lactones are selected from the group of γ-butyrolactone and y-valerolactone.

17. The method according to claim 7, wherein the ethers are selected form the group of dimethoxymethane, 1,2-dimethoxyethane, tetrahydrofuran, 2-methyl tetra hydrofuran, 1,3-dioxane, and 4-methyl-1,3-dioxolane.

18. The method according to claim 7, wherein the fluorinated esters are selected form the group of methyl formate, methyl acetate, ethyl acetate, methyl propionate, isopropyl acetate, n-butyl acetate, n-propyl propionate, and 2,2-difluoroethyl acetate.

19. The method according to claim 1, wherein said composition (COMP-F) comprises the salt-FSI in a concentration from about 1.0 to 60 wt. % based on the total weight of the composition (COMP-F).

20. The method according to claim 1, wherein said (COMP-F) comprises water in an amount below 100 ppm based on the total weight of the composition (COMP-F).
